(19) United States
(12) Patent Application Publication
(10) Pub. No.: US 2010/0046964 A1
(43) Pub. Date: Feb. 25, 2010

(54) Apparatus and Method for Reduction of Crosstalk of an Optical Transmitter

(75) Inventors: Jakke Sakari Makela, Turku (FI); Niko Santeri Porjo, Piikkio (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/197,551

(22) Filed: Aug. 25, 2008

(51) Int. Cl. H04B 10/04

(52) U.S. Cl. 398/201

(57) ABSTRACT

In accordance with an example embodiment of the present invention, an apparatus is provided, comprising a portion of semiconductor comprising an optical transmitter and an optically sensitive structure, wherein the semiconductor is covered with an interference filter at least in a first area comprising at least part of the optical transmitter and a second area comprising at least part of the optically sensitive structure, and wherein the interference filter of the first area is substantially optically separate from the interference filter of the second area.

### TECHNICAL FIELD

The present application relates generally to optical transmitters, and more specifically to an optical transmitter that is arranged with at least one optically sensitive structure on a single portion of semiconductor material.

### BACKGROUND

Electronic devices may contain one or more optical transmitters. An optical transmitter is a source of optical radiation, for example to illuminate a scene or to transmit communication, and sensors to detect optical radiation, e.g. to measure the luminosity of a scene or to receive communication.

Design requirements make it often necessary to build optical transmitters and optical receivers or sensors in close vicinity. For example, infrared communication usually takes place along the same line of sight for the transmit and the receive direction between devices. Therefore, the optical receiver may be placed in close vicinity of the optical transmitter.

Optical receivers and optical sensors are optically sensitive structures. Further, semiconductor structures performing digital or analogue functions may have optically sensitive properties, even though this is not an intended property for the digital or analogue function. Yet, due to the properties of the semiconductor material, such a sensitivity may exist. Optically sensitive structures may comprise structures that are sensitive to light or other radiation. Other radiation may comprise radiation in the electromagnetic spectrum, for example infrared or ultraviolet light.

Placing an optical transmitter in close vicinity of an optically sensitive structure may result in cross-talk or malfunction of the optically sensitive structure. For example, in infrared communication, a bi-directional communication may be set-up. Thus, communication from a first apparatus to a second apparatus may happen simultaneously with communication from the second apparatus to the first apparatus. Therefore, the transmitter and receiver are active on both apparatuses at the same time. Consequently, the signal from the close-by transmitter in the first apparatus may be received by the receiver of the first apparatus at a level sufficient to disturb reception of the signal transmitted from the second apparatus. Thus, correct interpretation of the received signal may be made impossible.

Correct reception and interpretation of a received signal in the first or second apparatus may be achieved if the transmitter is not active at the same time as the receiver of the same apparatus. This means that communication may only take place in one direction at a time. Thus, half the bandwidth is lost by not allowing bi-directional simultaneous communication.

Another way to enable bi-directional simultaneous communication is by avoiding crosstalk between the optical transmitter of the first or second apparatus and the optically sensitive structure of the same device. Mechanical structures with surfaces having a low reflectance are used for this purpose. For small devices, micro-structures or MEMS (micro electro-mechanical systems) may be used. These mechanical structures or MEMS may guide the light and avoid crosstalk towards optically sensitive structures.

In another example, a color sensor measures light sent out by a transmitter in the vicinity of the sensor that is reflected by a colored surface. By measuring the intensity at fixed wavelengths, a color profile of the surface may be deduced. Leakage from the transmitter to the receiver may be avoided in order to achieve an accurate representation of the color of the surface in the color profile.

### SUMMARY

Various aspects of the invention are set out in the claims.

In accordance with an example embodiment of the present invention, an apparatus is disclosed, comprising a portion of semiconductor comprising an optical transmitter and an optically sensitive structure. The semiconductor is covered with an interference filter at least in a first area comprising at least part of the optical transmitter and a second area comprising at least part of the optically sensitive structure, and the interference filter of the first area is substantially optically separate from to the interference filter of the second area.

In accordance with another example embodiment of the present invention, an apparatus is disclosed, comprising a portion of semiconductor comprising an optical transmitter and an optically sensitive structure. The semiconductor is covered with an interference filter at least in a first area comprising at least part of the optical transmitter and a second area comprising at least part of the optically sensitive structure, and the semiconductor comprises at least one impediment between the optical transmitter and the optically sensitive structure.

In accordance with another example embodiment of the present invention, a method is described, comprising providing a semiconductor comprising at least an optical transmitter and an optically sensitive structure, producing an interference filter on at least a first area of the semiconductor comprising at least part of the optical transmitter and a second area of the semiconductor comprising at least part of the optically sensitive structure. During the production process it is assured that the interference filter of the first area is substantially optically separate from to the interference filter of the second area.

### BRIEF DESCRIPTION OF THE DRAWINGS

For a more complete understanding of example embodiments of the present invention, reference is now made to the following descriptions taken in connection with the accompanying drawings in which:

FIG. 1 shows an example embodiment of an optical transceiver;

FIG. 2 shows another example embodiment of an optical transceiver;

FIG. 3 shows an example embodiment of an interference filter on a semiconductor, illustrating the passage of a light beam through the interference filter;

FIG. 4 shows an example embodiment of an interference filter on a semiconductor, illustrating the passage of another light beam through the interference filter;

FIG. 5 shows a transceiver according to an example embodiment of the invention;

FIG. 6 shows a transceiver having an impediment according to an example embodiment of the invention;

FIGS. 7a and 7b show another transceiver having an impediment according to a further example embodiment of a the invention;

FIGS. 8a and 8b show a transceiver having an impediment according to a further example embodiment of the invention;

FIG. 9 shows a perspective view of the transceiver of FIG. 8b;

FIG. 10 shows a plan view of yet another transceiver having a rectangular impediment according to a further example embodiment of the invention;

FIG. 11 shows a flow diagram of a method of manufacturing an optical transceiver in accordance with an example embodiment of the invention; and

FIG. 12 shows a flow diagram of a further method of manufacturing an optical transceiver in accordance with an example embodiment of the invention.

### DETAILED DESCRIPTION OF THE DRAWINGS

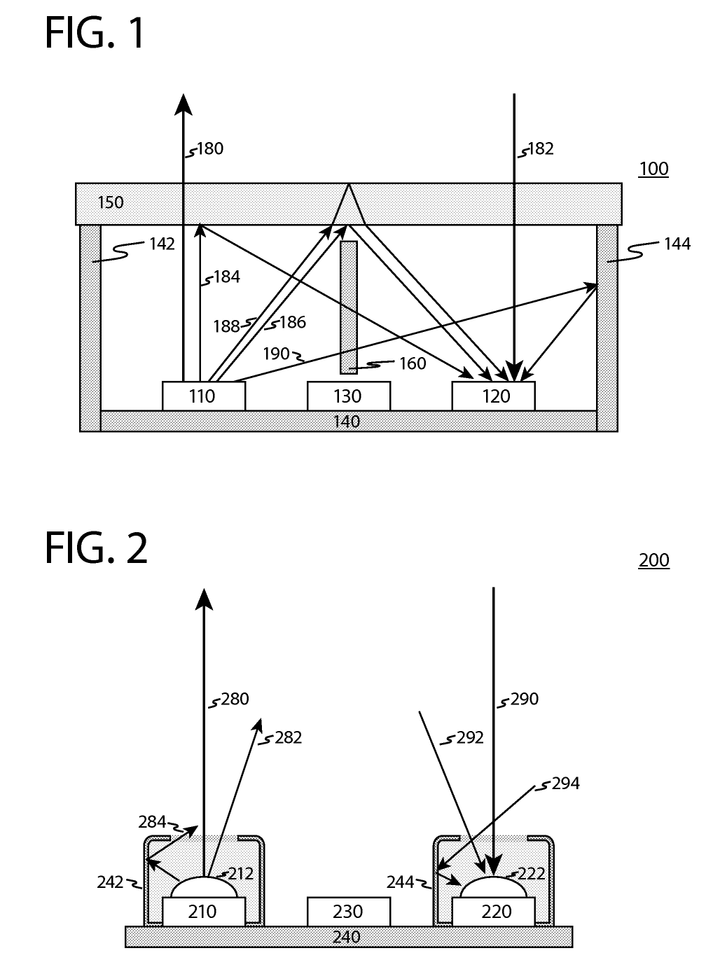

Example embodiments of the present invention and their potential advantages are best understood by referring to FIGS. 1 through 12 of the drawings.

FIG. 1 shows an example embodiment of an optical transceiver 100. Optical transceiver 100 comprises an optical transmitter 110, an optical receiver 120 and an integrated circuit (IC) 130. IC 130 may be used for controlling the optical transmitter 110 and/or the optical receiver 120 or for providing the optical transmitter 110 and/or the optical receiver 120 with power. Optical transmitter 110, optical receiver 120 and integrated circuit 130 are enclosed in a casing having a base 140, walls 142 and 144, and a protective window 150. In an example embodiment, the protective window covers the structure made from the base 140 and the walls 142 and 144. The protective window 150 allows light to pass through of at least a wavelength used by the optical transmitter 110 and/or the optical receiver 120. Arrows 180 and 182 show the desired light beams for the optical transmitter 110 and the optical receiver 120, respectively. However, unwanted light beams 184, 186, 188 and 190 from the transmitter may reach the receiver 120 by reflection or scattering on the walls 142 and 144, the base 140 and the protective window 150. For example, light beam 184 reaches the protective window 150 and is scattered so that it reaches the optical receiver 120. Light beam 186 is reflected in part by the inner surface of the protective window 150, and light beam 188 is reflected in part by the outer surface of the protective window 150. Surfaces of the protective window 150 may be coated to reflect less light. This will attenuate light beams reflected by the protective window 150, for example light beams 186 and 188.

Further, light beam 190 may reach the receiver by reflection on the wall 144. An opaque element 160 may be situated between the optical transmitter 110 and the optical receiver 120 in order to prevent at least light beams 184 and 190 from the optical transmitter 110 to reach the optical receiver 120.

FIG. 2 shows another example embodiment of an optical transceiver 200. Transceiver 200 comprises an optical transmitter 210, an optical receiver 220 and an IC 230. These components are mounted on base 240. Optical transmitter 210 and receiver 220 have lenses or micro lenses 212 and 222 respectively mounted in order to form directional light beams. For the transmitter 210, light transmitted in a direction perpendicular to the upper surface of the transmitter 210 has the strongest intensity as shown by arrow 280, whereas light transmitted in a direction diverting from the perpendicular direction has a weaker intensity. This is shown by arrows 282 and 284. Wall 242 with an opening in the top surface surrounds the transmitter 210. Even though the inner surface of the wall 242 may be painted with a colour that absorbs the light of a frequency that is transmitted by transmitter 210, small parts of the transmitted light may still be reflected as shown by arrow 284.

Likewise, lens or micro lens 222 directs incoming light beams onto the receiver 220, giving light beam 290 from a direction perpendicular to the upper surface of the receiver 220 a stronger weight compared to light beams from other directions, for example light beams 292 and 294. Similar to the transmitter, a wall 244 surrounds receiver 220 to prevent light beams from the sides, especially from transmitter 210, from reaching the receiver 220. An opening in the top surface of the wall 244 allows only light beams that divert from the perpendicular direction up to a certain degree to reach the receiver 220, for example light beam 292. Even though the wall 244 may be painted or coated with a paint that absorbs light of a frequency to which receiver 220 responds, a small portion of light beam 294 may still be reflected and reach the receiver 220.

The intensity of a light beam decreases with the area that is lighted by the beam leaving the transmitter. So, the intensity of the light beam is proportional to 1/r² with r being the distance from the transmitter to the lighted area. Thus, even though measures are taken to avoid crosstalk from transmitter 110, 210 to receiver 120, 220, like the opaque wall 160 in FIG. 1 or walls 242 and 244 in FIG. 2, the intensity of reflected beams, for example beams 186 and 188, may still be higher than the intensity of the desired beam 182 in FIG. 1. This is because the desired beam 182 travels a longer distance and therefore reaches the receiver 120 with a reduced intensity.

Due to the proportionality to 1/r², the intensity of any unwanted light beam like beams 184, 186, 188 or 190 in FIG. 1 may become stronger as transmitter 110, 210 and receiver 120, 220 are placed closer together, for example by closer integration. Transmitter 110, 210 and receiver 120, 220 may even be manufactured on one single portion of semiconductor, putting them even closer together. Also integrated circuit 130 and 230 may be integrated on the same single portion of semiconductor as transmitter 110, 210 and receiver 120, 220, respectively. So, the likelihood of crosstalk is increased by a shorter distance for unwanted light beams 184, 186, 188 and 190 caused by stronger integration.

In an example embodiment, an interference filter comprises a thin layer of a material with a refractive index different from materials adjacent to the thin layer or adjacent to the interference filter.

When an incident light beam encounters the interference filter, a first fraction of the light is reflected at a first surface of the interference filter, and a second fraction passes through the interference filter until it reaches a second surface of the interference filter. At the second surface, a part of the second fraction of the light beam leaves the filter, and another part is reflected back into the interference filter. The reflected part may partially leave the interference filter at the first surface where it may constructively or destructively interfere with the first reflected fraction of the light.

The thickness of the layer may be a small integer multiple of a quarter wavelength of interest for constructive or destructive interference, for example of a wavelength transmitted by an optical transmitter or received by an optical receiver. Light of other wavelengths may have at least partial constructive or destructive interference.

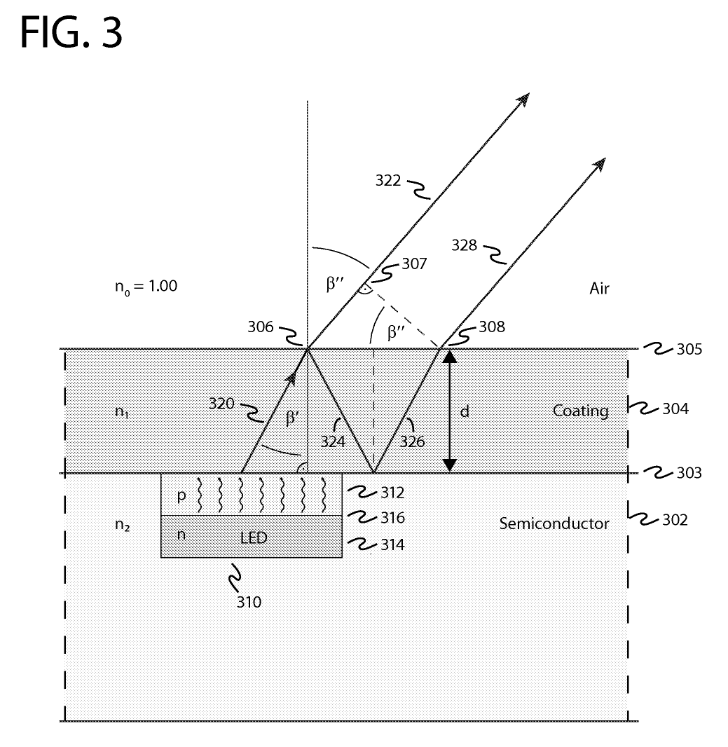

FIG. 3 shows an example embodiment of an interference filter 304 on a semiconductor 302, illustrating the passage of a light beam through the interference filter. The thickness of the interference filter 304 has been drawn in a large scale so that paths of the light beams within the interference filter can be shown in detail. Interference filter 304 may be applied as a coating on a surface of the semiconductor 302.

In the example structure of FIG. 3, semiconductor 302 comprises an optical transmitter 310. The transmitter may be a light emitting diode (LED) comprising an n-doped layer 314 and a p-doped layer 312, forming a pn-junction 316. If a current flows across the pn-junction 316, light is emitted, illustrated as small arrows in the p-doped layer 312, thus reaching a surface of the semiconductor 302.

Reflective and refractive properties of the coating and semiconductor are defined by the refractive indices n of the air n₀, coating 304 n₁ and semiconductor 302 n₂. For example, the semiconductor 302 may have a refractive index n₂=4, coating 304 may have a refractive index n₁=1.4 and the refractive index of air being approximately 1.00. Thus, in the example n₂>n₁>n₀.

An example ray or light beam 320 is shown that leaves semiconductor 302 and enters the coating layer 304. Ray 320 enters the coating layer 304 at an angle β′ relative to the normal. As ray 320 reaches the surface of the coating layer 304 at point 306, a first part of it leaves the coating as refracted ray 322 at an angle β″. A second part 324 of ray 320 is reflected into the coating at angle β′. The reflected part 324 of the ray 320 is again reflected in part at the surface 303 between semiconductor 302 and coating 304 as ray 326. A part of ray 326 then leaves the coating as ray 328 at point 308.

Angle β″ depends on the angle of incidence β′ of ray 320, on the refractive index n₁ of the coating and of the refractive index n₀ of air according to

$$sin ( {β}^{″} ) = sin ( {β}^{′} ) \cdot \frac{{n}_{1}}{{n}_{0}} . \qquad equation ( 1 )$$

Ray 328 travels a path that is longer compared to refracted ray 322 by the travelling distance of rays 324 and 326 minus the side 306-307 of a triangle defined by points 306, 307 and 308. Points 306 and 308 are the points where rays 322 and 328 leave the surface 305 of coating layer 304. Point 307 is geometrically constructed by projecting point 308 on ray 322 at an angle of 90°.

Thickness d of the coating 304 may be selected in such a way that for an incident ray 320 with β=0 rays 322 and 328 have a path difference (including any phase jumps or shifts) that corresponds to an integer multiple of a wavelength λ of incident ray 320, resulting in constructive superposition. Considering that reflection of ray 324 on the surface from coating 304 to semiconductor 302 adds a phase shift of approximately λ/12, thickness d may be selected as follows:

$$d = \frac{λ}{4 \cdot {n}_{1}} + k \cdot \frac{λ}{2} with integer k = 0 , 1 , 2 … . \qquad equation ( 2 )$$

Calculating the additional travel path l of ray 328 compared to ray 322 yields

$$l = \frac{2 \cdot d \cdot {n}_{1}}{cos ( {β}^{′} )} - 2 \cdot d \cdot tan ( {β}^{′} ) \cdot sin ( {β}^{″} ) ,$$

which may be transformed into

l=2·d·n·cos(β′) equation (3).

Replacing

$$d = \frac{λ}{4 \cdot {n}_{1}}$$

from equation (1) with k=0, the additional travel path l of
ray 328 is

$$l = \frac{λ}{2} \cdot cos ( {β}^{′} ) .$$

For the reflection of ray 324 on the surface from coating 304 to semiconductor 302 a phase shift of approximately λ/2 has to be added, so that for β′=0 there is constructive superposition, as required by equation (2). For increasing β′, l becomes smaller and the additional travel path l approaches λ/2, resulting in cancellation of rays 322 and 328.

Thus, the interference filter 304 causes a directional characteristic of rays 322 and 328 with a strong light intensity normal to surface 305 and a weaker light intensity at an increasing angle towards the normal.

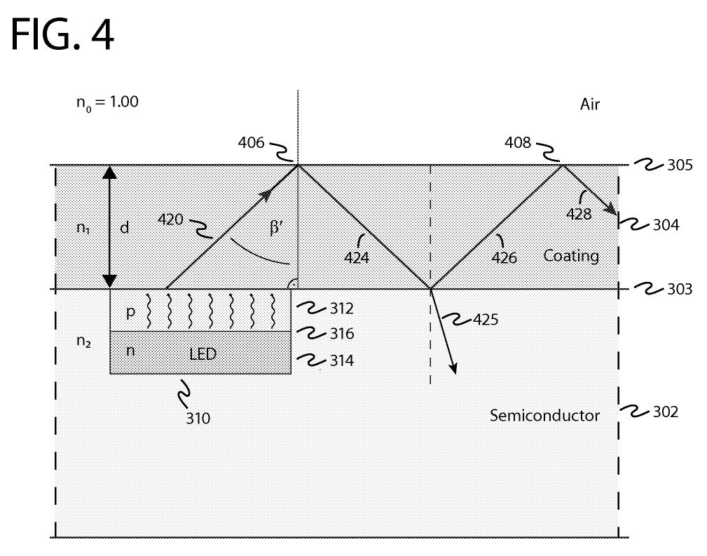

FIG. 4 shows an example embodiment of an interference filter on a semiconductor, illustrating the passage of another light beam through the interference filter. In FIG. 4, the same layer arrangement of optical transmitter 310, semiconductor 302 and interference filter 304 of FIG. 3 is shown. However, angle β′ is larger than the angle of internal reflection of coating 304. Thus, ray 420 is completely reflected into the coating 304 at point 406 as ray 424. Ray 424 hits surface 303 between coating 304 and semiconductor 302. A first part of ray 424 is refracted into the semiconductor as ray 425, a second part of ray 424 is reflected into the coating 304 as ray 426. Ray 426 hits surface 305 at point 408 at the angle β′ and is completely reflected as ray 428. Thus, light may travel within the coating layer 304.

In this embodiment, the coating layer 304 may have the technical effect of a light guide that makes the light travel in the direction of the surface of semiconductor 302 within the coating layer 304.

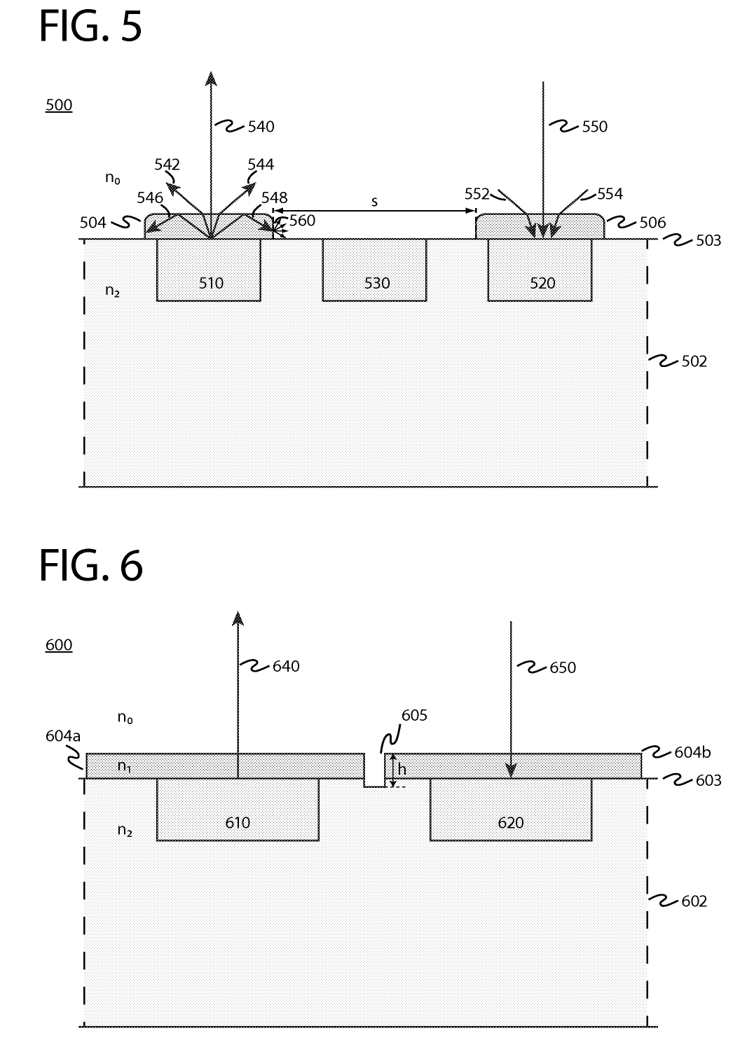

FIG. 5 shows a transceiver 500 according to an example embodiment of the invention as a cross section. Transceiver 500 comprises a semiconductor 502. Semiconductor 502 comprises an optical transmitter 510 and an optically sensitive structure 520. An interference filter comprising parts 504 and 506 covers at least a portion of semiconductor 502. The interference filter parts 504 and 506 may or may not form a continuous surface. In an example embodiment, interference filter parts 504 and 506 cover only parts of the semiconductor 502. For example, part 504 of the interference filter covers at least a portion of the optical transmitter 510 radiating light beams 540, 542, 544, 546 and 548. Part 506 of the interference filter covers at least a portion of the optically sensitive structure 520 which is responsive to light beams 550, 552 and 554. The optically sensitive structure may be an optical receiver, an optical sensor, or a portion of semiconductor that does not perform an optical function but that is nonetheless susceptible to optical radiation. For example, the optically sensitive structure may react to optical radiation of a certain intensity, wavelength, modulation etc. with malfunction. Malfunction may occur deterministically or statistically for a radiation of a certain intensity, duration, wavelength or modulation. Thus, for an optical radiation of a certain intensity, duration, wavelength and modulation malfunction of the optically sensitive structure may always occur, or malfunction may occur as a random process with a probability p, for example with a probability of 0.2 (20%).

Semiconductor 502 may also comprise an IC 530 that may or may not be covered by a part of the interference filter. In the embodiment of FIG. 5, IC 530 is disposed between optical transmitter 510 and the optically sensitive structure 520.

In the example embodiment, the part 504 of the interference filter covering the optical transmitter 510 is optically separate from to the part 506 of the interference filter covering the optically sensitive structure 520, for example an optical receiver or an optical sensor. Thus, in the example embodiment, optical transmitter 510 is not optically coupled to the optically sensitive structure 520, and no or no significant amount of light travelling from one part of the coating, for example part 504, reaches another part, for example part 506, in a way as described in relation to FIG. 4.

A small part of the light that travels in the direction of the surface of the semiconductor, for example light beam 548, may leave the coating at an edge of the coating, for example at edge 560, and may be refracted or scattered as indicated by small arrows on edge 560. A part of the scattered light may reach the optically sensitive structure 520 through interference filter 506. However, the intensity of the scattered light reaching the optically sensitive structure 520 may be low. Thus, no or only negligible interference or malfunction is caused at the optically sensitive structure 520. By making the surface of interference filter 504 at edge 560 uneven, light may be scattered more. Thus, less light is likely to reach the optically sensitive structure 520 through interference filter 506. Therefore, interference filters 504 and 506 are substantially optically separate.

In an example embodiment, the optical transmitter is configured to transmit light of a wavelength lambda, and the interference filter has a thickness of a multiple of lambda/(4*n₁), wherein n₁ is the refractive index of the material of the semiconductor.

In a further embodiment, the distance s between parts 504 and 506 is at least several times a wavelength of interest, for example a wavelength transmitted by the optical transmitter 510 or received by the optical receiver 520. By making the distance between parts 504 and 506 wide enough, significant coupling of light or tunneling from part 504 into part 506 can be prevented. In an example embodiment, the distance between parts 504 and 506 is at least 10 times a wavelength of interest.

In an example embodiment, optically separated parts of the interference filter (e.g. parts 504 and 506) are created by depositing the interference filter only on a number of unconnected areas on the surface 503 of the semiconductor 502, for example by using a mask on the surface of the semiconductor when depositing the interference filter. The mask may be removed later.

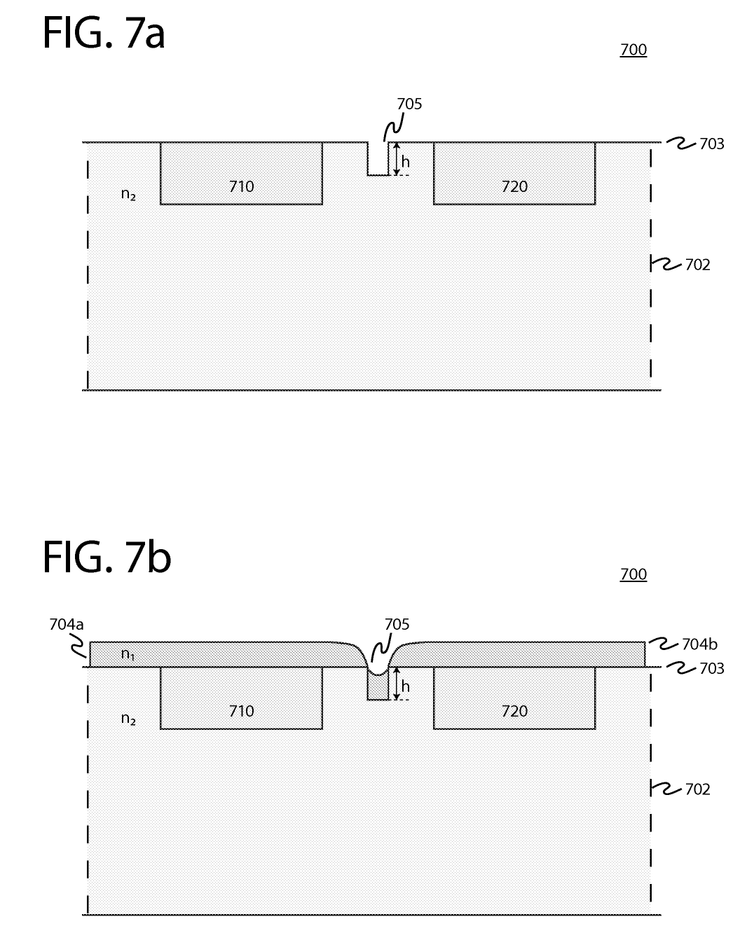

FIGS. 6, 7a and 7b show a transceiver having an impediment according to example embodiments of the invention. In each of the FIGS. 6, 7a and 7b a cross section is shown, in which optically separated parts of the interference filter are provided by having one or more impediments, e.g. grooves in the surface of the semiconductor material. In an example embodiment of the invention, the one or more grooves are of a depth larger than a thickness of the interference filter. Thus, the parts of the interference filter have no physical connection and are substantially optically separate.

In the example embodiment of FIG. 6, semiconductor 602 is covered by interference filter 604. Semiconductor 602 also comprises an optical transmitter 610, configured to emit light beam 640. Semiconductor 602 further comprises an optically sensitive structure 620, like an optical receiver, configured to receive light beam 650. After deposition of the interference filter 604, at least one groove 605 is made in the semiconductor, thus separating interference filter 604 in at least a first part 604a and a second part 604b. Because the depth of the at least one groove 605 is more than for example the thickness of the interference filter at or near the position of the groove, the separated parts of the interference filter do not have a physical connection and are substantially optically separate. The depth or height of the groove 605 is identified by ‘h’.

In a further example embodiment shown in FIGS. 7a and 7b, at least one groove 705 is prepared in semiconductor 702 before a coating of a material having a suitable refractive index is deposited to form an interference filter 704a, 704b. In FIG. 7a, semiconductor 702 comprises an optical transmitter 710 and an optically sensitive structure 720. The groove 705 is made between the optical transmitter 710 and the optically sensitive structure 720. The groove may be closer to the optical transmitter 710, it may be closer to the optically sensitive structure 720, or it may be in the middle. The groove may be distant from areas containing electronic circuitry in order to prevent damage to the electronic circuitry when preparing the groove 705. The depth h of the at least one groove 705 is more than the thickness of the interference filter 704a, 704b at or near the position of the groove. In a further example embodiment, the at least one groove 705 is deeper than a maximum thickness of the interference filter 704a, 704b.

FIG. 7b shows the semiconductor 702 with groove 705 after a material for the coating is deposited. The coating material is deposited in the desired thickness in an area above the optical transmitter 710 as interference filter 704a. The coating material may also be deposited in the desired thickness in an area above the optically sensitive structure 720 as interference filter 704b. The coating material may also be deposited in the groove. Due to the depth h of the groove 705, areas 704a and 704b of the interference filter are not physically connected and provide no or a very low optical coupling.

Depth h of the groove 705 may be more than the desired maximum thickness of the interference filter 704a, 704b. Thus, no connection is made even though the coating material may not be deposited evenly along the edges of the groove 705. In the example embodiment shown in FIG. 7b, coating material may be deposited higher at the edges of the groove 705 than in the middle of the groove 705.

In an example embodiment, material deposited in the groove 705 may be removed after formation of the interference filter.

In a further embodiment, a width of groove 705 is at least several times a wavelength of interest, for example a wavelength transmitted by the optical transmitter 710 or received by the optically sensitive structure 720. By making the width of the groove 705 wide enough, significant coupling of light or tunneling from part 704a into part 704b can be prevented. In an example embodiment, the width of the groove 705 is at least 10 times a wavelength of interest.

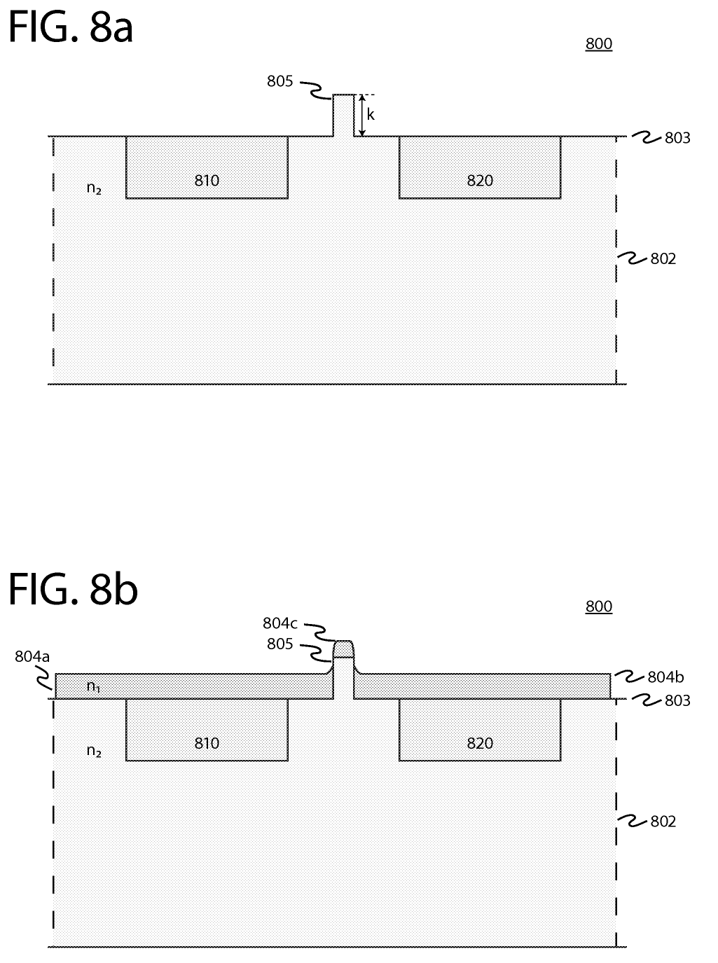

FIGS. 8a and 8b show a transceiver having an impediment, for example a ridge, according to a further example embodiment of the invention. In FIG. 8a, semiconductor 802 comprises an optical transmitter 810 and an optically sensitive structure 820. Surface 803 of the semiconductor 802 is interrupted by at least one impediment, for example a ridge 805, on the surface of the semiconductor. The ridge 805 may be between the optical transmitter 810 and the optically sensitive structure 820. The ridge 805 may be of a height k larger than a thickness of the interference filter before depositing the material of the interference filter. The ridge 805 may have a substantially rectangular cross-section. During deposition of the material forming the interference filter, material is deposited on either side of the at least one ridge 805 in the desired thickness without forming an optical connection, thus covering an area above the optical transmitter 810 forming interference filter 804a. The deposited coating material may further cover an area above the optically sensitive structure 820 forming interference filter 804b. A part of the material of the interference filter may also be deposited on the ridge 805 as interference filter 804c. Due to the height of the ridge 805, material that is deposited on the ridge is not optically connected to material deposited on the semiconductor 802. Thus, interference filters 804a and 804b are neither physically connected to each other nor to interference filter 804c and are substantially optically separate.

Height k of the ridge 805 may be more than the desired maximum thickness of the interference filter 804a, 804b. Thus, no connection is made even though the coating material may not be deposited evenly along the edges of the ridge 805. In the example embodiment shown in FIG. 8b, coating material may be deposited higher at the edges of the interference filter 804a and 804b along the edges of the ridge 805.

In an example embodiment, material deposited on the ridge 805 may be removed after deposition of the interference filter.

In a further embodiment, a width of ridge 805 is at least several times a wavelength of interest, for example a wavelength transmitted by the optical transmitter 810 or received by the optically sensitive structure 820. By making the width of the ridge 805 wide enough, significant coupling of light or tunneling from part 804a into part 804b can be prevented. In an example embodiment, the width of the ridge 805 is at least 10 times a wavelength of interest.

In a further example embodiment, material for providing the ridge may be opaque, so that no light of a wavelength used by the optical transmitter or by the optical receiver may leak from transmitter side to the receiver side of the ridge.

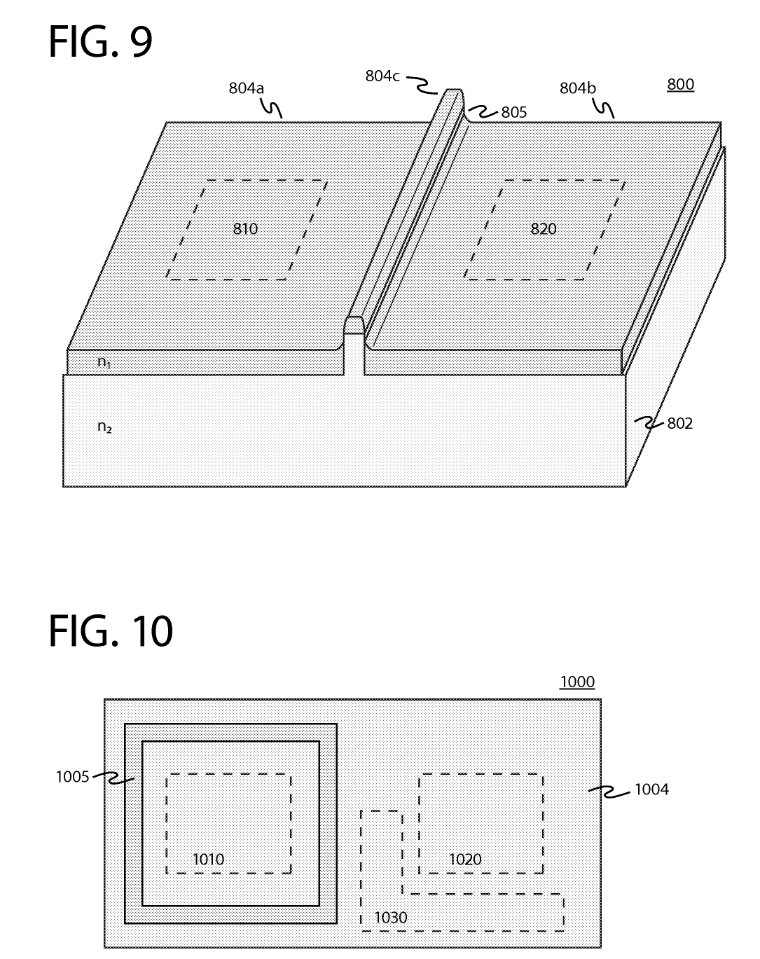

FIG. 9 shows a perspective view of the transceiver of FIG. 8b. Semiconductor 802 has a ridge 805 and is covered by interference filters 804a, 804b, and 804c. The dashed line around area 810 indicates an area comprising the optical transmitter and the dashed line around area 820 indicates an area comprising the optically sensitive structure. The ridge 805 is along a line between the area comprising the optical transmitter 810 and the area comprising the optically sensitive structure 820. Thus, optical coupling between the areas covered by interference filters 804a and 804b is substantially prevented.

The ridge of FIGS. 8 and 9 or the groove of FIGS. 6 and 7 need not be a straight line. FIG. 10 shows a plan view of yet another transceiver having a rectangular ridge or groove according to a further example embodiment of the invention. Transceiver 1000 comprises an optical transmitter 1010, an optically sensitive structure 1020, and integrated circuit 1030, for example a microprocessor. In order to prevent optical coupling between the optical transmitter 1010 and the optically sensitive structure 1020, an impediment 1005, for example a groove or a ridge is prepared around the optical transmitter 1010. The groove or ridge 1005 of FIG. 10 is rectangular in shape, but it may have any other form that prevents optical coupling between the optical transmitter 1010 and the optically sensitive structure 1020. For example, the impediment may be curved. Furthermore, the impediment 1005 may be closed or open. For example, the shape of the impediment may be a straight line as shown in FIG. 9 or a U-shape having an open end. In an example embodiment, the open end faces towards an edge of the transceiver 1000.

Embodiments of the transceiver may be used in apparatuses and devices. For example, an embodiment of the transceiver may be used in a mobile device like a mobile telephone, a PDA (or the like.

Further, embodiments of the transceiver may be used in a remote control or in a remote controllable device, for example in a device using infrared light for control or communication.

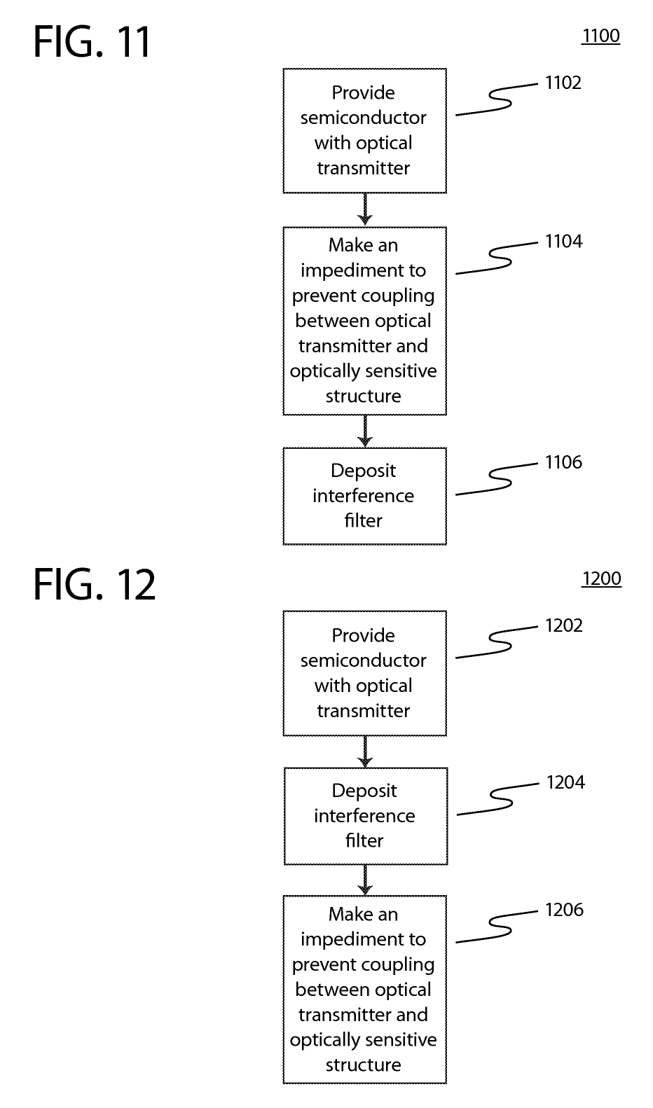

FIG. 11 shows a flow diagram of a method 1100 of manufacturing an optical transceiver in accordance with an example embodiment of the invention. At block 1102 a semiconductor comprising an optical transmitter is provided. At block 1104, an impediment is made to prevent coupling between the optical transmitter and at least one optically sensitive structure of the semiconductor, for example the optically sensitive structure of FIG. 7b. At block 1106, an interference filter is deposited on at least a portion of the semiconductor. By making the impediment, no further precautions have to be made regarding the location of the deposit of the material forming the interference filter. For example, no mask has to be provided for depositing material for the interference filter only in certain areas.

The method described with reference to FIG. 11 may be used to produce a structure having a groove as shown for example in FIG. 7b.

In a further embodiment, the method of FIG. 11 may be used to produce a structure having a ridge as shown for example in FIGS. 8b and 9.

In a further embodiment, the method of FIG. 11 may be modified by replacing the provision of an impediment by providing a mask separating an area comprising the optical transmitter and at least one other area. Thus, at block 1106, material forming an interference filter may be deposited on the semiconductor only in areas not covered by the mask. The mask may be removed after the material for the interference filter is deposited. Thus, a structure as shown for example in FIG. 5 may be produced.

FIG. 12 shows a flow diagram of a further method 1200 of manufacturing an optical transceiver in accordance with an example embodiment of the invention. At block 1202 a semiconductor comprising an optical transmitter is provided. At block 1204, an interference filter is deposited on the semiconductor. At block 1206, an impediment, for example a groove is made to prevent coupling between the optical transmitter and at least one optically sensitive structure of the semiconductor, for example the optically sensitive structure of FIG. 6.

The method described with reference to FIG. 12, may be used to produce a structure as shown for example in FIG. 6.

Without in any way limiting the scope, interpretation, or application of the claims appearing below, it is possible that a technical effect of one or more of the example embodiments disclosed herein may be that integration of an optical transmitter and an optical receiver is promoted while interference is reduced. Another possible technical effect of one or more of the example embodiments disclosed herein may be that in an optical transceiver, bidirectional simultaneous communication is made more reliable without complex light-guiding mountings.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising
a portion of semiconductor comprising an optical transmitter and an optically sensitive structure,
wherein the semiconductor is covered with an interference filter at least in a first area comprising at least part of the optical transmitter and a second area comprising at least part of the optically sensitive structure, and
wherein the interference filter of the first area is substantially optically separate from the interference filter of the second area.

2. The apparatus of claim 1, wherein the semiconductor comprises at least one impediment between the optical transmitter and the optically sensitive structure.

3. The apparatus of claim 2, wherein said at least one impediment is at least one of a groove and a ridge.

4. The apparatus of claim 3, wherein the at least one groove is of a depth greater than a thickness of the interference filter.

5. The apparatus of claim 3, wherein the at least one ridge is of a height greater than a thickness of the interference filter.

6. The apparatus of claim 1, wherein the interference filter has a refractive index less than a refractive index of a material of the semiconductor.

7. The apparatus of claim 1, wherein the optical transmitter is configured to transmit light of a wavelength lambda, and wherein the interference filter has a thickness of a multiple of lambda/(4*n₁), wherein n₁ is the refractive index of the material of the semiconductor.

8. The apparatus of claim 2, wherein the at least one impediment surrounds the optical transmitter at least partially.

9. The apparatus of claim 2, wherein the at least one impediment surrounds the optically sensitive structure at least partially.

10. An apparatus, comprising
a portion of semiconductor comprising an optical transmitter and an optically sensitive structure,
wherein the semiconductor is covered with an interference filter at least in a first area comprising at least part of the optical transmitter and a second area comprising at least part of the optically sensitive structure, and
wherein the semiconductor comprises at least one impediment between the optical transmitter and the optically sensitive structure.

11. The apparatus of claim 10, wherein the interference filter of the first area is optically separate from the interference filter of the second area.

12. The apparatus of claim 11, wherein said at least one impediment is at least one of a groove and a ridge.

13. The apparatus of claim 12, wherein the at least one groove is of a depth greater than a thickness of the interference filter.

14. The apparatus of claim 12, wherein the at least one ridge is of a height greater than a thickness of the interference filter.

15. The apparatus of claim 10, wherein the interference filter has a refractive index less than a refractive index of a material of the semiconductor.

16. The apparatus of claim 10, wherein the optical transmitter is configured to transmit light of a wavelength lambda, and wherein the interference filter has a thickness of a multiple of lambda/(4*n₁), wherein n₁ is the refractive index of the material of the semiconductor.

17. The apparatus of claim 10, wherein the at least one impediment surrounds the optical transmitter at least partially.

18. The apparatus of claim 10, wherein the at least one impediment surrounds the optically sensitive structure at least partially.

19. A method, comprising:
providing a semiconductor comprising at least an optical transmitter and an optically sensitive structure,
producing an interference filter on at least a first area of the semiconductor comprising at least part of the optical transmitter and a second area of the semiconductor comprising at least part of the optically sensitive structure,
wherein the interference filter of the first area is substantially optically separate from the interference filter of the second area.

20. The method of claim 19, wherein producing the interference filter further comprises creating an impediment between the optical transmitter and the optically sensitive structure.

21. The method of claim 20, wherein creating an impediment comprises making at least one groove in the semiconductor before depositing the interference filter.

22. The method of claim 21, wherein the at least one groove is of a depth greater than a thickness of the interference filter.

23. The method of claim 20, wherein creating an impediment further comprises making at least one groove in the semiconductor after depositing the interference filter.

24. The method of claim 23, wherein the at least one groove is of a depth greater than a thickness of the interference filter.

25. The method of claim 20, wherein creating an impediment comprises creating at least one ridge on the semiconductor before depositing the interference filter.

26. The method of claim 25, wherein the at least one ridge is of a height greater than a thickness of the interference filter.
